(19) United States
(12) Patent Application Publication
(10) Pub. No.: US 2026/0046111 A1
(43) Pub. Date: Feb. 12, 2026

(54) ELECTRONIC DEVICE AND METHOD FOR PERFORMING ENCRYPTED OPERATION IN ELECTRONIC DEVICE

(71) Applicant: SAMSUNG ELECTRONICS CO., LTD., Suwon-si (KR)

(72) Inventors: Taechan KIM, Suwon-si (KR); Chunghun BAEK, Suwon-si (KR)

(73) Assignee: SAMSUNG ELECTRONICS CO., LTD., Suwon-si (KR)

(21) Appl. No.: 19/361,596

(22) Filed: Oct. 17, 2025

Related U.S. Application Data
(63) Continuation of application No. PCT/KR2024/005137, filed on Apr. 17, 2024.

(30) Foreign Application Priority Data
Apr. 17, 2023 (KR) 10-2023-0050055
Feb. 16, 2024 (KR) 10-2024-0022257

(51) Int. Cl. H04L 9/06; G06F 21/72

(52) U.S. Cl. CPC H04L 9/0618; G06F 21/72

(57) ABSTRACT

An electronic device and method that identifies at least one garbled circuit ciphertext generated based on a garbling equation set corresponding to a target operation from the memory, provides the identified at least one garbled circuit ciphertext to an evaluator device through the communication circuit, obtains a first result value of the garbling equation corresponding to at least one input value from the evaluator device through the communication circuit, and identifies a second result value of the target operation corresponding to the at least one input value based on the first result value.

### CROSS-REFERENCE TO RELATED APPLICATIONS

This application is a continuation of International Application No. PCT/KR2024/005137, filed on Apr. 17, 2024, and claiming priority to Korean Patent Application No. 10-2023-0050055, filed on Apr. 17, 2023, in the Korean Intellectual Property Office, and Korean Patent Application No. 10-2024-0022257, filed on Feb. 16, 2024, in the Korean Intellectual Property Office, the disclosures of each of which are incorporated by reference herein in their entireties.

### BACKGROUND

### 1. Field

The disclosure relates to an electronic device and a method for performing an encrypted operation in an electronic device.

### 2. Description of Related Art

Garbled circuits (GC) are one of the most promising primitives for secure multi-party computation (MPC). A general solution for GC was provided by Andrew Yao, the 1986 Turing Award winner. Yao proved that arbitrary polynomial functions may be computed securely (without revealing the players' inputs) by ‘garbling’ general circuits for arbitrary polynomial functions.

For example, if there is a way for A to send necessary information to B, GC may evaluate arbitrary functions privately (i.e., without revealing inputs to the function to be computed).

Since Yao's important work, the enhancement direction of GC has mainly focused on reducing the size of data (e.g., garbled circuit ciphertext) to be transmitted. However, despite the long history of GC, a considerable amount of research has focused on garbling Boolean circuits. GC is still considered less suitable for secure operations of arithmetic circuits compared to other MPC primitives such as secret sharing. Therefore, when performing multi-party operations through garbling circuits, a method is required that may safely transmit while reducing the size of garbled circuit ciphertext transmitted and received.

The above-described information may be provided as related art for the purpose of helping understanding of the disclosure. No claim or determination is made as to whether any of the foregoing is applicable as background art in relation to the disclosure.

### SUMMARY

According to an embodiment, there may be provided an electronic device and a method for performing encrypted operations in an electronic device by setting a garbling equation through arithmetic garbled circuits when performing multi-party operations through garbling circuits.

According to an aspect of the disclosure, there is provided an electronic device including: memory storing instructions; a communication circuit; and at least one processor, wherein the instructions, when executed by the at least one processor individually or collectively, cause the electronic device to: identify at least one garbled circuit ciphertext generated based on a garbling equation set corresponding to a target operation from the memory; provide the identified at least one garbled circuit ciphertext to an evaluator device through the communication circuit; obtain a first result value of the garbling equation corresponding to at least one input value from the evaluator device through the communication circuit; and identify a second result value of the target operation corresponding to the at least one input value based on the first result value.

The garbling equation may be set based on a number of at least one variable included in the target operation and a domain for the at least one variable.

The garbling equation may be set based on a degree of at least one variable included in the target operation.

The first result value may be generated by the evaluator device based on the at least one garbled circuit ciphertext.

The instructions cause the electronic device to: obtain the at least one input value from the evaluator device; generate a random bit string of a set number of bits based on the obtained at least one input value; and provide the generated random bit string to the evaluator device.

The at least one garbled circuit ciphertext may be generated based on coefficients included in the garbling equation.

Based on the target operation being a multiplication operation of x and y, the garbling equation may correspond to: C+xG₁+yG₂=M\vec{H}+yAₓ+(x+α)(y±β)Δ where x and y may be input values, C, G₁, and G₂ may be coefficients of the garbling equation, M may be a matrix set to output 1 when each input value is 0, \vec{H} may be a hash vector corresponding to each input value, α and β may be permutation bits of a garbler, and Δ may be a variable for offset.

The at least one garbled circuit ciphertext includes the G₁ and the G₂.

Based on the target operation being a square operation of x, the garbling equation may correspond to: C+xG₁+x²G₂=M\vec{H}−(x+α)²Δ where x may be an input value, C, G₁, and G₂ may be coefficients of the garbling equation, M may be a matrix set to output 1 when each input value is 0, \vec{H} may be a hash vector corresponding to the input value, α may be a permutation bit of a garbler, and Δ may be a variable for offset.

The at least one garbled circuit ciphertext includes the G₁ and the G₂.

According to an aspect of the disclosure, there is provided a method for performing an encrypted operation in an electronic device, the method including: identifying at least one garbled circuit ciphertext generated based on a garbling equation set corresponding to a target operation; providing the identified at least one garbled circuit ciphertext to an evaluator device; obtaining a first result value of the garbling equation corresponding to at least one input value from the evaluator device; and identifying a second result value of the target operation corresponding to the at least one input value based on the first result value.

The garbling equation may be set based on a number of at least one variable included in the target operation and a domain for the at least one variable.

The garbling equation may be set based on a degree of at least one variable included in the target operation.

The first result value may be generated by the evaluator device based on the at least one garbled circuit ciphertext.

The method may include: obtaining the at least one input value from the evaluator device; generating a random bit string of a set number of bits based on the obtained at least one input value; and transmitting the generated random bit string to the evaluator device.

The at least one garbled circuit ciphertext is generated based on coefficients included in the garbling equation.

Based on the target operation being a multiplication operation of x and y, the garbling equation may correspond to: C+xG₁+yG₂=M\vec{H}+yAₓ+(x+α)(y+β)Δ where x and y may be input values, C, G₁, and G₂ may be coefficients of the garbling equation, M may be a matrix set to output 1 when each input value is 0, \vec{H} may be a hash vector corresponding to each input value, α and β may be permutation bits of a garbler, and Δ may be a variable for offset.

The at least one garbled circuit ciphertext includes the G₁ and the G₂.

Based on the target operation being a square operation of x, the garbling equation may correspond to: C+xG₁+x²G₂=M\vec{H}−(x+α)²Δ where x may be an input value, C, G₁, and G₂ may be coefficients of the garbling equation, M may be a matrix set to output 1 when each input value is 0, \vec{H} may be a hash vector corresponding to the input value, α may be a permutation bit of a garbler, and Δ may be a variable for offset.

The at least one garbled circuit ciphertext includes the G₁ and the G₂.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 is a view illustrating a garbling system according to an embodiment;

FIG. 2 is a block diagram illustrating configurations of a garbler device and an evaluator device according to an embodiment;

FIG. 3 is a flowchart illustrating an operation method in a garbler device according to an embodiment; and

FIG. 4 is a flowchart illustrating an operation method in an evaluator device according to an embodiment.

### DETAILED DESCRIPTION

Garbled Circuits (GC) enable two parties who do not trust each other to jointly compute functions on their private inputs where only the output is revealed by the functions and nothing else. Since these concepts were first introduced by Yao, several approaches have focused on reducing the size of garbled circuit ciphertext transmitted from one party (hereinafter referred to as ‘garbler’ for convenience of description) to another party (hereinafter referred to as ‘evaluator’ for convenience of description).

According to an embodiment, studies on garbled circuits may represent functions to be computed as Boolean circuits composed of XOR/AND gates and generate garbled circuit ciphertext under a gate-by-gate paradigm. Due to the free-XOR structure, garbling XOR gates may be performed freely, i.e., the garbler does not need to transmit ciphertext to the evaluator to compute XOR gates. A series of subsequent studies aim to reduce the cost of garbling AND gates. As an example of a garbling scheme, AND gates may be garbled using 1.5κ (kappa) bit ciphertext. Here, κ is a computational security parameter. Meanwhile, recent research has proven that 1.5κ bits are optimal for AND gates. Therefore, scalability may decrease as the multiplicative depth of the circuit increases. To garble arithmetic operations with the approach, the function should first be represented as a Boolean circuit, and then the GC construction may be applied gate by gate. For example, even for a single 16-bit integer addition, when κ=128, about 360 bytes may be required.

Hereinafter, an example of implementing garbled circuits using Boolean circuits (or Boolean garbled circuits) is described.

According to an embodiment, a multiplication operation of x and y may be represented as an AND gate in a Boolean operation circuit. The truth values of the AND gate may be represented as illustrated in Table 1 below.

TABLE 1

| x | y | z(=xy) |
|---|---|---|
| 0 | 0 | 0 |
| 0 | 1 | 0 |
| 1 | 0 | 0 |
| 1 | 1 | 1 |

Here, a random bit string set corresponding to an input x value of 0 may be denoted as A₀, a random bit string set corresponding to an input x value of 1 may be denoted as A₁, a random bit string set corresponding to an input y value of 0 may be denoted as B₀, and a random bit string set corresponding to an input y value of 1 may be denoted as B₁. Further, a random bit string set corresponding to an output z(=xy) value of 0 may be denoted as C₀, and a random bit string set corresponding to an output z value of 1 may be denoted as C₁. In other words, the input values of each input (x, y) or output values of output (z) may be garbled with random bit strings of 128 bits (κ=128) or 256 bits (κ=256) as described above. The input value garbled with the random bit string is referred to as a garbled input, but is not limited to this term. In this case, based on the Boolean operation circuit for the multiplication operation, garbled circuit ciphertexts G₀, G₁, G₂, G₃ may be generated as shown in Equation 1 below.

$${G}_{0} = {C}_{0} ⊕ H ( {A}_{0} , {B}_{0} ) \qquad [ Equation 1 ]$$

$${G}_{1} = {C}_{0} ⊕ H ( {A}_{0} , {B}_{1} )$$

$${G}_{2} = {C}_{0} ⊕ H ( {A}_{1} , {B}_{0} )$$

$${G}_{3} = {C}_{1} ⊕ H ( {A}_{1} , {B}_{1} )$$

For example, referring to Table 1 and Equation 1 above, the number of garbled circuit ciphertexts may be determined according to the domain of each input value. For example, when the domain of input values is 2 (i.e., when input values be composed of 0 or 1), the garbled circuit ciphertext corresponding to the xy operation may be composed of 4 (=2*2), which is the combination of the number of x input values and the number of y input values.

According to an embodiment, a garbler (e.g., garbler device) may transfer the garbled circuit ciphertexts G₀, G₁, G₂, G₃ to an evaluator (e.g., evaluator device). The evaluator who received the garbled circuit ciphertext may generate garbled inputs by garbling input values, or receive the generated garbled inputs from the garbler. For example, the evaluator may receive either of the garbled inputs Aₓ and B_{y} from the garbler, or generate either Aₓ or B_{y} independently. As an example, the evaluator may compute the garbled input corresponding to specific input values as shown in Equation 2 below and transmit the computed result value to the garbler.

$${C}_{{0}^{=}} {G}_{1} ⊕ H ( {A}_{0} , {B}_{1} ) \qquad [ Equation 2 ]$$

According to an embodiment, by receiving C₀ determined by Equation 2 from the evaluator, the garbler may identify that the result value of xy, which is the multiplication operation of two inputs (i.e., x, y), is 0, even though it does not know at least one of the x, y values.

Although an embodiment illustrated the case where the domain is 2, according to an embodiment, when the domain of each input is p, the number of garbled circuit ciphertexts may be p². Therefore, as described above, in the case of garbled circuits using Boolean circuits, as the number of domains increases, the number of garbled circuit ciphertexts increases significantly, so the amount of data that the garbler needs to transmit to the evaluator may increase rapidly.

The following embodiments describe methods for reducing the size of ciphertext transmitted and received between devices by generating garbled circuit ciphertext based on arithmetic garbling circuits using algebraic garbling instead of Boolean garbling circuits.

FIG. 1 is a view illustrating a garbling system according to an embodiment.

Referring to FIG. 1, a garbling system may include a first device 110 and a second device 120. The first device 110 may be referred to as a first electronic device or a garbler device, but the embodiments described below are not limited to these terms. The second device 120 may be referred to as a second electronic device or an evaluator device, but the embodiments described below are not limited to these terms. Communication between the first device 110 and the second device 120 may correspond to communication between electronic devices, and may also correspond to communication between a client and a server. Further, communication between the first device 110 and the second device 120 may correspond to communication between chips (e.g., integrated circuits) within an electronic device. According to various embodiments, the garbling system may further include a third device, and data transferred and received between the first device 110 and the second device 120 may be transferred through the third device as an intermediary. In this case, the third device may perform a role of generating at least one data necessary for the garbling system (e.g., at least one input value or at least one garbled circuit ciphertext, a result value of a garbling equation (e.g., first result value)), or identifying a result value of a target operation (e.g., second result value). Various embodiments described below may also be implemented by further including the third device.

According to an embodiment, the first device 110 may set a garbling equation corresponding to a target operation. For example, the garbling equation may be generalized to a finite field of prime characteristic (e.g., Galois field, GF) by implementing an arithmetic garbling circuit through algebraic garbling. A detailed description of this is provided later.

According to an embodiment, the first device 110 may generate garbled circuit ciphertext (G₁, . . . , G₂₍ₚ₋₁₎) based on the garbling equation (e.g., algebraic equation). The number of garbled circuit ciphertexts may be relatively smaller compared to when implementing garbled circuits using Boolean circuits (or Boolean garbled circuits). For example, to perform an xy operation where the domain of each input value of inputs x, y is p, p² garbled circuit ciphertexts may be required in Boolean circuits as described above. On the other hand, in arithmetic garbling circuits, 2(p-1) garbled circuit ciphertexts may be required for the same operation. Specific examples of this are described below.

According to an embodiment, the first device 110 may transmit the generated garbled circuit ciphertext (G₁, . . . , G₂₍ₚ₋₁₎) to the second device 120. According to an embodiment, the first device 110 may transmit random bit strings (Aₓ, B_{y}) corresponding to input values (x, y) to the second device 120. The random bit strings may be transmitted without exposing the input values or whether the input values are transmitted to the first device 110 and/or the second device 120 through the oblivious transfer (OT) method, and the embodiments described below are not limited thereto.

According to an embodiment, the second device 120 may generate a result value (\tilde{C}) of the garbling equation corresponding to the input values using the garbled circuit ciphertext (G₁, . . . , G₂₍ₚ₋₁₎) received from the first device 110 and the random bit strings (Aₓ, B_{y}) corresponding to the input values (x, y). The garbling equation used in the second device 120 may be the same, similar, or different from the garbling equation used in the first device 110. The garbling equation used in the first device 110 may be referred to as a ‘first garbling equation’ for convenience of description, and the garbling equation used in the second device 120 may be referred to as a ‘second garbling equation’.

According to an embodiment, the second device 120 may transmit the result value (\tilde{C}) of the garbling equation corresponding to the input values (e.g., first result value) to the first device 110. The first device 110 may identify the result value of the target operation corresponding to the input values (e.g., z=xy) (hereinafter referred to as ‘second result value’ for convenience of description) based on the result value (\tilde{C}) of the garbling equation (e.g., first result value) transmitted from the second device 120.

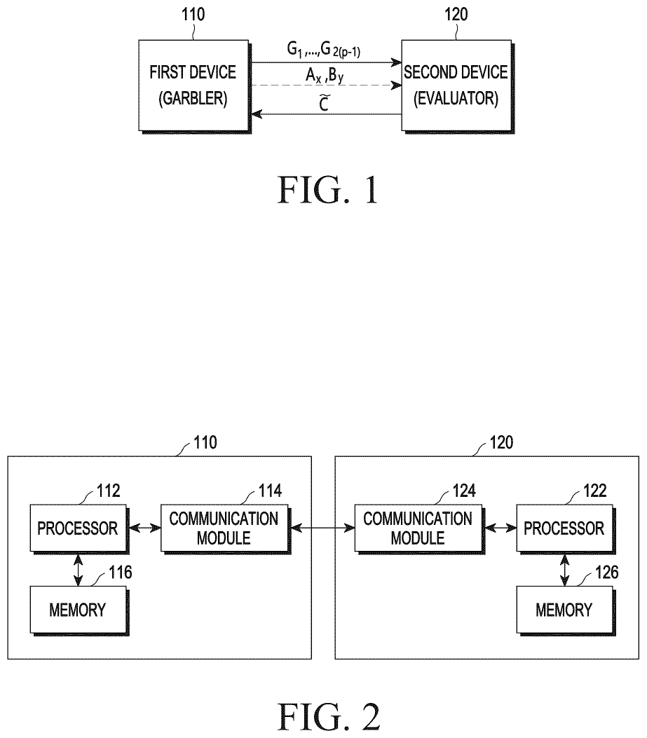

FIG. 2 is a block diagram illustrating configurations of a garbler device and an evaluator device according to an embodiment.

Referring to FIG. 2, according to an embodiment, the first device 110 (e.g., garbler device) may include a processor 112, a communication module 114, and a memory 116. The second device 120 (e.g., evaluator device) may include a processor 122, a communication module 124, and a memory 126.

According to an embodiment, the processor 112 of the first device 110 may set a garbling equation corresponding to a target operation. The processor 112 may generate at least one garbled circuit ciphertext based on the set garbling equation. The generated at least one garbled circuit ciphertext may be stored in the memory 116. When the target operation between the first device 110 and the second device 120 is preset, the at least one garbled circuit ciphertext may be generated in an external device and then stored in advance in the memory 116. According to an embodiment, the processor 112 of the first device 110 may transmit the at least one garbled circuit ciphertext to the second device 120 through the communication module 114.

According to an embodiment, the second device 120 may receive the at least one garbled circuit ciphertext through the communication module 124. The processor 122 of the second device 120 may identify the at least one garbled circuit ciphertext received through the communication module 124. According to an embodiment, the second device 120 may generate at least one input value or at least one garbling input obtained by garbling at least one input value, or receive it from the first device 110. For example, the second device 120 may receive the at least one input value or at least one garbling input obtained by garbling at least one input value from the first device 110 without exposing the input values or whether the input values are transmitted to the first device 110 and/or the second device 120 through the oblivious transfer (OT) method. The second device 120 may store the at least one input value or at least one garbling input obtained by garbling at least one input value in the memory 126.

According to an embodiment, the processor 122 of the second device 120 may generate a result value (e.g., first result value) by inputting the at least one input value or at least one garbling input obtained by garbling at least one input value stored in the memory 126, and at least one garbled circuit ciphertext into a garbling equation (e.g., second garbling equation).

According to an embodiment, the processor 122 of the second device 120 may transmit the generated result value (e.g., first result value) to the first device 110 through the communication module 124. The first device 110 may receive the result value (e.g., first result value) transmitted from the second device 120 through the communication module 114.

According to an embodiment, the processor 112 of the first device 110 may identify the result value of the corresponding operation corresponding to the input values based on the result value received through the communication module 114.

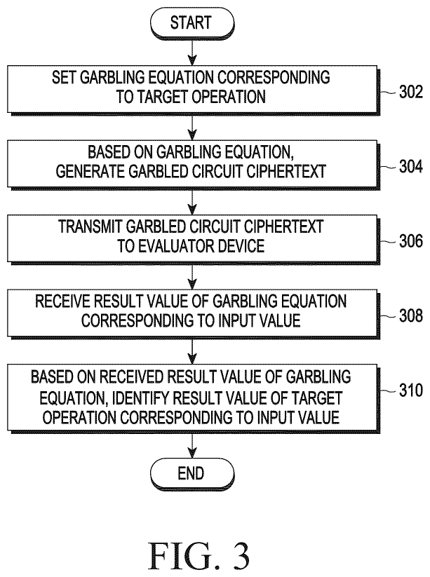

FIG. 3 is a flowchart illustrating an operation method in a garbler device according to an embodiment.

Referring to FIG. 3, according to an embodiment, in operation 302, an electronic device (e.g., first device 110) may set a garbling equation corresponding to a target operation.

According to an embodiment, in operation 304, the electronic device may generate at least one garbled circuit ciphertext based on the set garbling equation.

According to an embodiment, in operation 306, the electronic device may transmit the generated garbled circuit ciphertext to an evaluator device (e.g., second device 120).

According to an embodiment, in operation 308, the electronic device may receive a result value of the garbling equation corresponding to input values (or garbling inputs) (e.g., first result value) from the evaluator device.

According to an embodiment, in operation 310, the electronic device may identify a result value of the target operation corresponding to the input values (e.g., second result value) based on the received result value of the garbling equation.

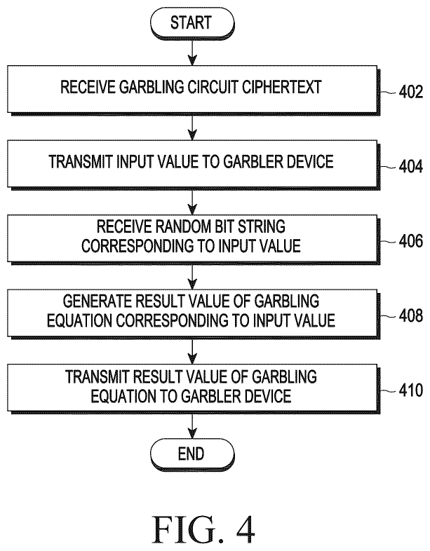

FIG. 4 is a flowchart illustrating an operation method in an evaluator device according to an embodiment.

Referring to FIG. 4, according to an embodiment, in operation 402, an evaluator device (e.g., second device 120) may receive at least one garbling circuit ciphertext from a garbler device (e.g., first device 110).

According to an embodiment, in operation 404, the evaluator device may transmit input values for at least one input to the garbler device.

According to an embodiment, in operation 406, the evaluator device may receive random bit strings (e.g., garbling inputs) corresponding to the input values from the garbler device.

According to an embodiment, in operation 408, the evaluator device may generate a result value of the garbling equation corresponding to the input values (or garbling inputs) (e.g., first result value).

According to an embodiment, in operation 410, the evaluator device may transmit the result value of the garbling equation to the garbler device.

Hereinafter, specific embodiments for setting a garbling equation corresponding to a target operation and identifying the result value of the target operation by generating garbled circuit ciphertext according to an embodiment as described above are described. To facilitate understanding, an embodiment where the domain of each input value of inputs x, y is 2 and the target operation is xy operation is described first, and then various embodiments for generalized target operations are described.

According to an embodiment, when a target operation is determined as described above, a garbling equation corresponding to the target operation may be set. For example, when the target operation is a multiplication operation of x and y (e.g., based on the target operation being a multiplication operation of x and y), and the domain of each input value is 2, the garbling equation may be set as shown in Equation 3 below.

$$C + {xG}_{1} + {yG}_{2} = M \vec{H} + {yA}_{x} + ( x + α ) ( y + β ) Δ \qquad [ Equation 3 ]$$

In Equation 3 above, x and y are input values, C, G₁, and G₂ are coefficients of the garbling equation corresponding to garbling circuit ciphertext, M may represent a matrix set to output 1 when each input value is 0. \vec{H} may represent a hash vector corresponding to each input value, α, β may represent permutation bits of the garbler, and Δ may represent a variable for offset.

According to an embodiment, in Equation 3 above, M may be represented as M=[x+1 xy+1 y], and \vec{H} may be represented as \vec{H}=(H(A₀), H(A₁), H(B₀), H(B₁)). In other words, by substituting M and A into Equation 3 above, the garbling equation may be represented as shown in Equation 4 below.

$$C + {xG}_{1} + {yG}_{2} = ( x + 1 ) H ( {A}_{0} ) + xH ( {A}_{1} ) + ( y + 1 ) H ( {B}_{0} ) + yH ( {B}_{1} ) + {yA}_{x} + ( x + α ) ( y + β ) Δ \qquad [ Equation 4 ]$$

By substituting (x, y)=(1, 0) into Equation 4 above, Equation 5 below may be generated.

$$C + {G}_{1} = H ( {A}_{1} ) + H ( {B}_{0} ) + ( α + 1 ) βΔ \qquad [ Equation 5 ]$$

By substituting (x, y)=(0, 1) into Equation 4 above, Equation 6 below may be generated.

$$C + {G}_{2} = H ( {A}_{0} ) + H ( {B}_{1} ) + α ( β + 1 ) Δ \qquad [ Equation 6 ]$$

By substituting (x, y)=(0, 0) into Equation 4 above, Equation 7 below may be generated.

$$C = H ( {A}_{0} ) + H ( {B}_{0} ) + αβΔ \qquad [ Equation 7 ]$$

By solving Equations 5, 6, and 7 above simultaneously, garbled circuit ciphertexts G₁ and G₂ may be calculated as shown in Equations 8 and 9 below.

$${G}_{1} = H ( {A}_{0} ) + H ( {A}_{1} ) + βΔ \qquad [ Equation 8 ]$$

$${G}_{2} = H ( {B}_{0} ) + H ( {B}_{1} ) + αΔ \qquad [ Equation 9 ]$$

According to an embodiment, the processor of the electronic device may set A₀, Δ, and β, and calculate A₁ by Equation 10 below.

$${A}_{1} = {A}_{0} ⊕ Δ \qquad [ Equation 10 ]$$

Next, the processor of the electronic device may generate garbled circuit ciphertext G₁ by substituting A₀, A₁, Δ, and β into Equation 8 above.

According to an embodiment, the processor of the electronic device may set B₀ and α, and calculate B₁ by Equation 11 below.

$${B}_{1} = {B}_{0} ⊕ Δ \qquad [ Equation 11 ]$$

Next, the processor of the electronic device may generate garbled circuit ciphertext G₂ by substituting B₀, B₁, Δ, and α into Equation 9 above. Equations 10 and 11 described above may be referred to as free-XOR operations, but are not limited to this term.

According to an embodiment, the garbler device (e.g., first device) may transmit the generated garbled circuit ciphertexts G₁ and G₂ to the evaluator device (e.g., second device).

According to an embodiment, the evaluator device may receive the garbled circuit ciphertexts G₁ and G₂ transmitted from the garbler device. The evaluator device may generate a result value (\tilde{C}) of the garbling equation corresponding to the input values by substituting random bit strings Aₓ, B_{y}, G₁, and G₂ for inputs x, y into the garbling equation (e.g., second garbling equation) of Equation 12 below.

$$\tilde{C} = H ( {A}_{x} ) + H ( {B}_{y} ) + {yA}_{x} + {xG}_{1} + {yG}_{2} \qquad [ Equation 12 ]$$

The result value (\tilde{C}) of Equation 12 above may correspond to C+(x+α)(y+β)Δ according to Equation 3 described above.

According to an embodiment, the evaluator device may transmit the calculated result value (\tilde{C}) to the garbler device. The garbler device may receive the result value (\tilde{C}). The garbler device may determine the operation result of xy as 0 if the received result value (\tilde{C}) corresponds to C, and may determine the operation result of xy as 1 if the received result value (\tilde{C}) corresponds to C+Δ. According to an embodiment, the garbler device may determine the operation result XY for X and Y, which are x and y randomly masked by α and β respectively, as 0 or 1.

Hereinafter, various embodiments for setting a garbling equation by extending the corresponding operation to a generalized equation according to an embodiment are described.

According to an embodiment, when constructing arithmetic garbling circuits, for arithmetic calculations on rings modulo integer (p), its structure may freely support addition and multiplication by constants. Other simple operations, exponentiations and multiplication may be garbled using p-1 and 6p-5 ciphertexts respectively. The cost for multiplication may later be decreased to 2p-2 based on the concept of the half-gate method. For arithmetic on relatively large integers, these may represent integers as tuples of integers modulo small primes using the Chinese remainder theorem (CRT), and then apply the construction for each prime modulus.

In the embodiments described below, methods for further reducing the cost of garbling arbitrary 2-input polynomial gates are described. The embodiments described below describe garbling structures for arithmetic calculations. For example, the embodiments described below may be based on the concept called algebraic garbling. In the embodiments described below, the concept of algebraic garbling may be generalized from the Boolean case to finite fields of prime characteristic.

<Basic Arithmetic Calculation Modulo p>

As a natural result of the embodiments, the structure described below may perform the following gates, namely addition, exponentiations, and multiplication (mod p) at costs of ciphertext size 0, p-1, and 2(p-1) respectively.

Further, any automorphism for Fₚ (which may be represented as a univariate polynomial for Fₚ) may be garbled at the same cost as exponentiation, i.e., at the cost of (p-1) ciphertexts.

### <Garbling of Arbitrary 2-Input Arithmetic Gates>

According to an embodiment, first, garbling of bivariate polynomials of the form F(X)Y for polynomial F∈Fₚ[X] may be considered. According to an embodiment, this may be garbled with 3(p-1) ciphertexts by first applying a projection gate for F(X) (at a cost of (p-1) ciphertexts), and then applying a multiplication gate to compute F(X)Y (at a cost of 2(p-1) ciphertexts).

Meanwhile, according to an embodiment, the cost may be further decreased to 2(p-1)+ε (for some small ε>0). As a result, garbling bivariate polynomials of the form

$${\sum }_{i = 0}^{d} {F}_{i} ( X ) {Y}^{i}$$

may be decreased to about 2(p-1) ciphertexts, a 25% reduction compared to conventional approaches.

### <Generalization of Garbling Equation>

According to an embodiment, most of the existing garbling structures may be set as equations referred to as garbling equations. The garbling equations may be generalized from garbling equations for binary fields for garbling Boolean circuits to the case of arbitrary prime fields to handle arithmetic circuits mod p.

### <Application of Dicing Technique>

According to an embodiment, in the structure for arbitrary polynomials, the evaluator may apply several linear combinations dependent on hidden private input values. The garbler may obliviously transmit information about such linear combinations to the evaluator. This technique may be referred to as the dicing technique, but is not limited to this term. According to an embodiment, the method may be transmitted without exposing the input values or whether the input values are transmitted to the first device 110 and/or the second device 120 through the oblivious transfer (OT) method, but is not limited thereto.

### <Preliminaries>

According to an embodiment, the finite field Fₚ of prime characteristic p and the bivariate polynomial ring Fₚ[x, y] may be handled. For example, Boolean logic values {0, 1} may be considered as elements of F₂. Boolean operations XOR/AND may be considered as addition/multiplication over F₂ respectively. According to an embodiment, vectors and their entries may be denoted as \vec{ν}=(ν₁, . . . , νₙ). Matrices may be denoted as bold capital letters as M.

### <Garbling Technique>

According to an embodiment, garbling scheme abstraction may be used. For example, the garbling scheme may be composed of the following algorithms:
Gb: For input 1^{κ} and circuit f, output (F, e, d), where F is a garbled circuit, e is encoding information, and d is decoding information.
En: For input (e, x), where e is as above and x is an appropriate input for f, outputs garbled input X.
Ev: For input (F, X), outputs garbled output Y.
De: For input (d, Y), returns output y.

The garbling scheme defined as above is accurate, and if (F, e, d)←Gb(1^{κ}, f), it satisfies De(d, Ev(F, En(e, x)))=F(x) for all x.

In the following description, according to an embodiment, an overview of garbling circuit (GC) construction and optimization is provided. Further, the algebraic representation of garbling circuits is briefly reviewed. In the embodiments described below, x may be considered as a computational security parameter.

### <Overview of GC Structure>

Most practical GC structures focus on garbling Boolean circuits through gate-by-gate structures. A Boolean gate of the structure with two input wires a and b and one output wire c may be considered. To garble the gate, the garbler may select two κ-bit random wire labels A₀ and A₁ (B₀ and B₁ respectively) for input wire a (b respectively). The garbler secretly knows that A_{α} and A_{β} correspond to truth value 0 for some α, β∈Fₚ. The other labels A_{1+α} and B_{1+β} are encoded values of truth value 1. The addition of subscripts may be calculated over F₂. The bits α and β may be referred to as permute bits (exchange or substitution), but are not limited to these terms.

According to an embodiment, according to the hidden truth values, the evaluator may hold one wire label per input wire. For example, if the truth value of wire a is v∈F₂, only A_{v+α} may be obtained. This may be performed by receiving labels directly from the garbler (if the garbler knows v) or using techniques such as oblivious transfer (if the evaluator knows v).

### <Point-and-Permute>

According to an embodiment, the point-and-permute technique may be considered. Using this technique, the evaluator may know the subscript of the wire label they hold. This means that if the evaluator's input labels are Aᵢ and Bⱼ for some i, j∈F₂, they know the values of i and j. These values may be referred to as color bits. Color bits may often be implemented as the least significant bit of the wire label, i.e., lsb(Aᵢ)=i and lsb(Bⱼ)=j. Therefore, the wire labels of each wire may be selected so that the least significant bits are opposite to each other.

### <Free-XOR>

According to an embodiment, the free-XOR setting may be considered. In this setting, the garbler may select a random secret offset Δ that is global to the entire circuit. Wire labels may be selected such that A₀+A₁=B₀+B₁=Δ instead of selecting them independently. It should be noted that addition is performed over F_{2*}, which is the same as XOR operation. By selecting Δ such that lsb(Δ)=1, free-XOR may be made compatible with point-and-permute.

Then, using free-XOR, the evaluator may freely obtain the output label for the XOR gate by applying a simple XOR operation. To see why, it suffices to identify that for v=i+α and w=j+β, Aᵢ+Bⱼ=(A_{α}+B_{β})+(v+w)Δ. It should be noted that v and w are truth values for the input wires for the evaluator's color bits (i, j) and the garbler's permutation bits (α, β). The garbler may set A_{α}+B_{β} as the output label encoding 0. For input (Aᵢ, Bⱼ), the evaluator may calculate Aᵢ+Bⱼ=(A_{α}+B_{β})+(v+w)Δ, which encodes v+w, the XORed result of v and w.

### <Garbled Circuit>

With free-XOR, most practical GC constructions may focus on garbling AND gates. Garbled circuits using free-XOR and point-and-permute may be reviewed. The garbler may set a κ-bit random string C as the output label corresponding to truth value 0. Then, the garbler may generate four ciphertexts (e.g., garbling circuit ciphertext) by calculating G_{i,j} defined as shown in Equation 13 below for all (i, j) ∈F²₂.

$${G}_{i , j} := C + ( v \cdot w ) Δ + H ( {A}_{i} , {B}_{j} ) = C + ( i + α ) ( j + β ) Δ + H ( {A}_{i} , {B}_{j} ) \qquad [ Equation 13 ]$$

In Equation 13 above, H represents a random oracle outputting a κ-bit string. Intuitively, if the evaluator holds (i, j) for (i, j) ∈F²², they may decrypt G_{i,j} using their input as a one-time key and obtain the desired output label C+(v·w)Δ+H(Aᵢ, Bⱼ)

### <Half-Gate Technique>

In the half-gate garbling scheme, a GC construction for AND gates with 2κ-bit ciphertext may be obtained. By selecting permutation bits (α, β), the garbler may set C:=H(A₀)+H(B₀)+αβΔ as the output label for truth value 0. Then, two ciphertexts may be generated as G₀:=H(A₀)+H(A₁)+βΔ and G₁:=H(B₀)+H(B₁)+Δ₀+αΔ. At inputs Aᵢ and Bⱼ, the evaluator may calculate H(Aᵢ)+H(Bⱼ)+iG₀+jG₁+jAᵢ to obtain the output label C+(i+α)(+β)Δ.

### <Algebraic Garbling>

According to an embodiment, the garbling scheme may be represented as algebraic equations referred to as garbling equations. Then, the construction of GC may be understood as finding appropriate formulas for garbling equations.

For better understanding, an example of the half-gate construction for AND gates is described. B_{y} observing that for x, y ∈F₂, H(Aₓ)=(x+1)H(A₀)+xH(Aᵢ) and H(B_{y})=(y+1)H(B₀)+yH(B₁), the evaluator's action may be represented as shown in Equation 14 below.

$$C + ( x + α ) ( 𝓎 + β ) Δ = ( x + 1 ) H ( {A}_{0} ) + xH ( {A}_{1} ) + ( 𝓎 + 1 ) H ( {B}_{0} ) + 𝓎 H ( {B}_{1} ) + {xG}_{0} + 𝓎 {G}_{1} + 𝓎 ( {A}_{0} + x Δ ) . \qquad [ Equation 14 ]$$

Rearranging the equation of Equation 14 above (since we are working on characteristic 2, X=−X for X∈F_{2*}), we may obtain Equation 15 below.

$$C + {xG}_{0} + {yG}_{1} = ( x + 1 ) H ( {A}_{0} ) + xH ( {A}_{1} ) + ( 𝓎 + 1 ) H ( {B}_{0} ) + 𝓎 H ( {B}_{1} ) + 𝓎 ( {A}_{0} + x Δ ) + ( x + α ) ( 𝓎 + β ) Δ . \qquad [ Equation 15 ]$$

Indeed, we may see that the garbler's choices C, G₀ and G₁ (coefficients on the left side) were made such that the equality of the equation holds for all x, y ∈F₂.

In general, it may be identified that most GC constructions have garbling equations of the form shown in Equation 16 below.

$${V ( C , {G}_{1} , … , {G}_{s} )}^{T} = M \vec{H} + {r}_{A} ( {A}_{0} + x Δ ) + {r}_{B} ( {B}_{0} + 𝓎 Δ ) + g ( x + α , 𝓎 + β ) Δ , \qquad [ Equation 16 ]$$

Here, g is the target Boolean function. For the half-gate technique, g is the AND gate, i.e., multiplication over F₂, and M=[x+1×y+1 y], V=[1×y], r_{A}=y and r_{B}=0 may be set.

The process of constructing the garbling scheme may be performed in the following steps:
(1) First, it is possible to determine the vector \vec{H} composed of random oracle responses made by the garbler.
(2) Then, M may be set in a way that reflects what operations the evaluator will apply to \vec{H}. Since the evaluator's input depends on color bits (x, y), M may be present on F_{2*}[x,y]. In the example of the half-gate method, \vec{MH} may be chosen to be H(Aₓ)+H(B_{y}).
(3) V may be selected such that the space on F_{2*} spanned by elements of V is the same as the space extended by M. For example, in the half-gate method, it may be identified that span(M)=span(V)={A₀+Δ₁+Δ₂y: Aᵢ∈F_{2*}}.
(4) The rest of the expression may be determined to belong to span(V). In the previous example, we may identify that y(A₀+xΔ)+(x+α)(y+β)Δ∈ span(V).

Once the garbling equation is constructed, the garbler may determine the output label and ciphertext by comparing the coefficients on both sides of the garbling equation. On the opposite side, the evaluator may recover the desired output label by evaluating \vec{MH}+W(G₁, . . . , Gₛ)+W(G₁, . . . , Gₛ)^{T}+r_{A}Aₓ+r_{B}B_{y} at (x, y)=(i, j) using their inputs Aᵢ and Bⱼ. Here, W is a matrix satisfying V=[1∥W]. For now, we assume that the values r_{A} and r_{B} all depend only on color bits so that the evaluator may perform the calculation. However, according to an embodiment, for main constructions, we need to consider cases where r_{A} and r_{B} also depend on permutation bits, which may not be revealed to the evaluator. This issue is discussed later.

### <Free Addition/Point-and-Permute>

According to an embodiment, a garbling scheme for arithmetic circuits on ring modulo may be provided. For example, a natural generalization of the free-XOR and point-and-permute techniques for Boolean circuits to arbitrary arithmetic circuit modulo p may be provided. For example, while generally applicable to any integer p, for mathematical convenience we illustrate the case of primes. The following description will describe this generalization.

<Free Addition Mod p>

It should be noted that in the Boolean case, each wire label carries a logical value in F₂. For arithmetic operations on modulus p, wire labels may carry values in F. And wire labels may be represented as vectors in F rather than bit strings. For i∈Fₚ, the encoding of i on wire a may be set as Wₐⁱ=Wₐ⁰+iΔp (addition is on Fₚ). Here, Wₐ⁰ and A_{β} may be random vectors for Fₚ. The value Wₐ⁰ represents the encoding of 0∈Fₚ. Similar to free-XOR, this generalization allows addition modulo p to be calculated from Equation 17 below.

$${W}_{a}^{i} + {W}_{b}^{j} = ( {W}_{a}^{0} + {W}_{b}^{0} ) + ( i + j ) {Δ}_{p} . \qquad [ Equation 17 ]$$

From now on, wire labels are represented as vectors over Fₚ of dimension λₚ, where λₚ=κ/log₂(p). In other words, the bit length of the wire label is κ. If obvious from context, subscripts are omitted, and vectors may be simply represented as elements in F_{pλ} instead of F_{pλ′}.

### <Point and Permute>

In the generalization of the point-and-permute technique, according to an embodiment, color digits/permute digits may be considered instead of bits. More specifically, according to an embodiment, the color digit may be defined as the last element of the wire label. For wire label W, this value may be denoted as color(W). In the Boolean case, color(W)=lsb(W) may be used.

In free-addition using the point-and-permute setting, the global free-addition offset Δₚ may be selected such that color(Δₚ)=1∈Fₚ. This may be represented as shown in Equation 18 below.

$$color ( {W}_{a}^{x} ) = color ( {W}_{a}^{0} ) + x color ( {Δ}_{p} ) = color ( {W}_{a}^{0} ) + x . \qquad [ Equation 18 ]$$

For example, the color digit of the wire label may be allocated as a random cyclic shift of Fₚ. According to an embodiment, we define the permutation digit as the color digit of the wire label corresponding to truth value 0∈Fₚ, i.e., α:=color(Wₐ⁰) represents the permutation bit at wire a, and similarly β:=color(W_{b}⁰) represents the permutation bit at wire b. Once the permutation digits are fixed, we also denote Aₓ:=Wₐ^{X-α} and B_{y}:=W_{b}^{y-β}, so that color(Aₓ)=x and color(B_{y})=y for all x, y∈Fp. Therefore, as in the free-XOR setting, we may assume that the subscript (or color digit) of the wire label is known to the evaluator. However, note that the color digit allocated to the encoding of 0 is known only to the garbler.

Hereinafter, concepts for efficient garbling of arithmetic circuits according to an embodiment are described. The description has examined efficient garbling schemes for Boolean gates and described the algebraic garbling method for constructing garbling circuits using garbling equations. These techniques are for Boolean gates and appropriate modifications may be necessary to utilize them for target arithmetic circuits. In the following description, methods for constructing garbling equations for arithmetic circuits defined on prime fields is discussed. Further, in this process, some of the coefficients of the garbling equation should be randomized for security, and randomization methods is discussed. In addition, we consider arithmetic circuits of prime fields as target circuits with input labels Aₓ and B_{y}, where x and y may be color digits respectively. As described above, the free-addition and point-and-permute settings are also assumed in the embodiments described below.

### <Generalization of Garbling Equation>

Let's recall the process of obtaining garbling equations for Boolean gates. In the evaluator's action, the output label C+g(x+α, y+β)Δ is obtained as an appropriate linear combination of random oracle responses and input labels, where g corresponds to the target circuit. This linear combination depends on the color bits held by the evaluator, and the equation for color bits x, y representing this relationship may be represented as shown in Equation 16 above.

As described above, according to an embodiment, the construction of Equation 16 above starts with determining \vec{H}, and then M and V may be naturally selected accordingly. The input of the random oracle is composed of the input labels of the garbled circuit, and the number of columns of M and V may vary according to how the input is applied. M determines which items of \vec{H} are included in the linear combination, and since the evaluator may only control items corresponding to color bits, M may be composed of polynomials with value 1 at bits corresponding to those items and value 0 otherwise. For example, if \vec{H} includes H(Aᵢ), M may include x+1 and x for H(A₀) and H(A₁) respectively. Then, V is selected such that span(M)=span(V), and r_{A} and r_{B} are selected such that the rest of the equation belongs to span(V).

Now, let's extend the garbling equation to the case of arithmetic circuit modulo p following this process. Here, p may be a prime integer with p>3. Since the output label C+g(x+α, y+β)Δ obtained by the evaluator is a vector on Fₚ, extending Equation 16, it may be represented as shown in Equation 19 below.

$${V ( C , {G}_{1} , … , {G}_{s} )}^{T} = M \vec{H} + {r}_{A} ( {A}_{0} + x Δ ) + {r}_{B} ( {B}_{0} + 𝓎 Δ ) - g ( x + α , 𝓎 + β ) Δ , \qquad [ Equation 19 ]$$

Here, g is the target arithmetic circuit modulus, and all operations may be performed on modulus p. Once it is decided what arbitrary oracle queries to perform, the vector \vec{H} is determined, and then M and V may be naturally designated from it. The most important thing in \vec{H} is how the input of the random oracle for each item is applied and how M and V are determined accordingly. As in the binary case, since the evaluator may only control items corresponding to their color digits, M should be composed of polynomials with value 1 at digits corresponding to those items and 0 otherwise. It may be easily seen that polynomials defined as follows satisfy this property.

### Definition 1

The Lagrange basis of polynomials for Fₚ is a set of polynomials {l₀(x), . . . , lₚ₋₁(x)}, which may be defined by Equation 20 below.

$${ℓ}_{i} ( x ) := {\prod }_{0 \leq j < p , j \neq i} \frac{x - j}{i - j} for i = 0 , … , p - 1. \qquad [ Equation 20 ]$$

It should be noted that [symbol] (x)=1 for x=i, and otherwise, [symbol] (x)=0.

\vec{H} If H=(H(A₀), . . . , H(Δₚ₋₁)), we take M={l₀(x), . . . , lₚ₋₁(x)}, and thus obtain

$$M \vec{H} = {\sum }_{k = 0}^{p - 1} H ( {A}_{k} ) {l}_{k} ( x ) .$$

For color digit i, \vec{MH} is evaluated as H(Aᵢ) at x=i. Further, from the fact that span(M)=Fₚ[x], we may set V=[1 x . . . x^{p-1}] using the standard basis of Fₚ[x].

Hereinafter, various embodiments for constructing garbled circuits according to target operation circuits according to an embodiment are described. The following embodiments will show the process of discovering r_{A} and r_{B} with each example. For better understanding, the following embodiments assume p=3.

### Embodiment 1: Exponentiation

The case where the target circuit is g(x)=x² may be considered. Here the evaluator may have input label Aₓ with color digit x. Then, the garbling equation may be represented as shown in Equation 21 below.

$${V ( C , {G}_{1} , … , {G}_{s} )}^{T} = M \vec{H} + {r}_{A} ( {A}_{0} + x Δ ) + {r}_{B} ( {B}_{0} + 𝓎 Δ ) - {( x + α )}^{2} Δ \qquad [ Equation 21 ]$$

According to an embodiment, since g is a 1-variable function, \vec{H}=(H(A₀), H(A₁), H(A₂)) may be set. Further, we may set M=[l₀(x) l₁(x) l₂(x)]=[2x²+1 2x²+2x 2x²+x] and V=[1×x²]. Since (x+α)² is already in span(V)=Fₚ[x], we may set r_{A}=r_{B}=0. Then, the garbling equation may be represented as shown in Equation 22 below.

$$C + {G}_{1} x + {G}_{2} {x}^{2} = M \vec{H} - {( x - α )}^{2} Δ . \qquad [ Equation 22 ]$$

According to an embodiment, the garbler may select output label C and ciphertexts (e.g., garbled circuit ciphertext) G₁, G₂ as shown in Equation 23 below.

$$C = H ( {A}_{0} ) - {α}^{2} Δ \qquad [ Equation 23 ]$$

$${G}_{1} = 2 H ( {A}_{1} ) + H ( {A}_{2} ) + 2 αΔ$$

$${G}_{2} = 2 H ( {A}_{0} ) + 2 H ( {A}_{1} ) + 2 H ( {A}_{2} ) - Δ .$$

And the evaluator may obtain the output label shown in Equation 24 below.

$$C + {( x + α )}^{2} Δ = H ( {A}_{x} ) - {G}_{1} x - {G}_{2} {x}^{2} \qquad [ Equation 24 ]$$

Here, x is the color digit. To garble the exponential circuit g, p-1=2 ciphertexts may be required. In fact, it may be easily identified that any 1-input arithmetic circuit g(x)=Fₚ[x] may also be garbled with the same \vec{H}, and the number of ciphertexts required in this case is also p-1.

### Embodiment 2: Multiplication

According to an embodiment, the case of g(x, y)=xy where the evaluator has input labels Aₓ and B_{y} with color digits x and y respectively may be considered. Since g is a 2-variable function, it may be set as shown in Equation 25 below.

$$\vec{H} = ( H ( {A}_{0} ) , H ( {A}_{1} ) , H ( {A}_{2} ) , H ( {B}_{0} ) , H ( {B}_{1} ) , H ( {B}_{2} ) ) \qquad [ Equation 25 ]$$

$$M = [ {ℓ}_{0} ( x ) {ℓ}_{1} ( x ) {ℓ}_{2} ( x ) {ℓ}_{0} ( 𝓎 ) {ℓ}_{1} ( 𝓎 ) {ℓ}_{2} ( 𝓎 ) ]$$

$$V = [ 1 x {x}^{2} 𝓎 {𝓎}^{2} ] .$$

In the (x+α)(y+β)Δ term, only xyΔ does not belong to span(V). Therefore, we may set r_{A}=y and r_{B}=0 to eliminate xyΔ. Then, the garbling equation may be represented as shown in Equation 26 below.

$$C + {G}_{1} x + {G}_{2} {x}^{2} + {G}_{3} 𝓎 + {G}_{4} {𝓎}^{2} = M \vec{H} + 𝓎 ( {A}_{0} + x Δ ) - ( x + α ) ( 𝓎 + β ) Δ . \qquad [ Equation 26 ]$$

According to an embodiment, the garbler may select C and Gᵢ by comparing coefficients, and the evaluator may obtain the output label as shown in Equation 27 below.

$$C + ( x + α ) ( y + β ) Δ = H ( {A}_{x} ) + H ( {B}_{𝓎} ) + 𝓎 {A}_{x} - {G}_{1} x - {G}_{2} {x}^{2} - {G}_{3} 𝓎 - {G}_{4} {𝓎}^{2} . \qquad [ Equation 27 ]$$

In this case, 2(p-1)=4 ciphertexts may be required to garble the multiplication circuit.

$$g ( x , y ) = {x}^{2} {y}^{2} > \qquad < Embodiment 3$$

The case of g(x, y)=x²y² where the evaluator has input labels Aₓ and B_{y} with color digits x and y respectively may be considered.

According to an embodiment, this circuit may be garbled using the same \vec{H}, M and V as in Embodiment 2 described above. Then, the right side of Equation 19 above should belong to span(V)=Fₚ[x]+Fₚ[y]. Since A₀, B₀ and Δ are selected independently, the polynomials r_{A}, r_{B} and r_{A}x+r_{B}y−(x+α)²(y+β)² should be within span(V). However, since r_{A}∈ span(V), it may not include the xy²-term. Similarly, r_{B} may not include the x²y-term, so r_{A}x+r_{B}y may not delete x²y² from (x+α)²(y+β)². In conclusion, if \vec{H} consists only of arbitrary oracles with one input, we may see that this circuit may not be garbled at once.

In fact, for all arithmetic circuits of Fₚ[x, y], this circuit may be garbled by constructing a garbling equation with \vec{H} composed of H(Aᵢ, Bⱼ). In this case, M may be composed of { [symbol] (x) [symbol] (y): 0≤i, j<p}, V=[1x . . . x^{p-1}y . . . y . . . y^{p-1}], and r_{A}=r_{B}=0. For example, the garbling equation may require p²-1 ciphertexts. For efficiency, instead of this approach using 2-input random oracles, we may perform garbling sequentially using 1-input random oracles. If the target circuit is g(x, y)=x^{m}yⁿ for 2≤m,n<p, we may perform three garblings: x^{m}, yⁿ and their multiplication. In this case, 4(p-1) ciphertexts are required to garble g(x, y), which is more efficient than when using 2-input random oracles, which requires p²-1 ciphertexts. Further, we propose methods to reduce this complexity in the following description.

### <Private Component Garbling>

According to an embodiment, since the evaluator calculates the output label using color digits, they should be able to evaluate the garbling equation at the color digits held by the evaluator. In the examples in the previous section, V, \vec{MH}, r_{A} and r_{B} may be evaluated at color digits without additional information, so the garbling equation may as well. However, there may be cases where the evaluator may not evaluate the garbling equation with only the given information. Even if V and M are constructed to be evaluated by the evaluator, r_{A} and r_{B} should play a role of canceling portions of g(x+α, y+β) that do not belong to span(V), and those portions may include α and β that the evaluator may not access.

In this case, additional information needs to be provided so that the evaluator may evaluate the garbling equation. The following embodiments describe methods to solve this problem.

According to an embodiment, the case of arithmetic circuit g(x, y)=x²y where the evaluator has input labels Aₓ and B_{y} with color digits x and y respectively may be considered. According to an embodiment, this circuit may be garbled using the same \vec{H}, M and V as in Embodiment 2 described above. Since (x+α)²(y+β)Δ∈ (x²+2αx)yΔ+span(V) and (x²+2αx)yΔ is not within span(V), this term should be deleted using r_{A} and r_{B}. Therefore, according to an embodiment, we may set r_{A}=0 and r_{B}=x²+2αx to delete (x²+2αx)yΔ. Accordingly, the garbling equation may be represented as shown in Equation 28 below.

$${V ( C , {G}_{1} , … , {G}_{4} )}^{T} = M \vec{H} + ( {x}^{2} + 2 α x ) ( {B}_{0} + y Δ ) - {( x - α )}^{2} ( y + β ) Δ . \qquad [ Equation 28 ]$$

The evaluator may obtain the output label C+(x+α)²(y+β)Δ by calculating Equation 29 below.

$$H ( {A}_{x} ) + H ( {B}_{y} ) + ( {x}^{2} + 2 α x ) {B}_{y} - {G}_{1} x - {G}_{2} {x}^{2} - {G}_{3} y - {G}_{4} {y}^{2} . \qquad [ Equation 29 ]$$

For this evaluation, information about r_{B}=x²+2αx should be provided to the evaluator, and a information should not be exposed to the evaluator. Therefore, a method is needed for the garbler to provide r_{B} to the evaluator without exposing α.

As a method to solve this problem, an approach may be considered where the evaluator may only obtain the evaluation values of r_{A} and r_{B} at color digits without knowing r_{A} and r_{B}. Since this may be similar to the principle of garbled circuits, we present an approach to garble r_{A} and r_{B} instead of g(x, y) using garbling equations. Since the output obtained is a 1-digit evaluation value rather than a λ-digit output label as in the case of garbled circuits, we may construct \vec{H} using a random oracle H′ that returns 1 digit.

According to an embodiment, r_{A} and r_{B} should be within span(V) from the fact that A₀, B₀ and Δ are selected independently. Therefore, the garbling equation for r_{A} may be represented as shown in Equation 30 below for some

$$\text{?} ϵ \text{?}$$

$$\text{?} \text{indicates text missing or illegible when filed}$$

according to an embodiment.

$$V \vec{z} = M \vec{H} + {r}_{A} \qquad [ Equation 30 ]$$

According to an embodiment, the garbler may use this equation to calculate relatively short ciphertext \vec{z} and additionally provide it to the evaluator. The evaluator may use \vec{z} to obtain the evaluation value at the color digit rather than the polynomial r_{A}. The garbling process of r_{B} may be applied in a similar manner.

According to an embodiment, one important point to consider is that r_{A} and r_{B} should be randomly designated. If polynomial r_{A}(x, y)∈Fₚ[x, y] includes α or β in its coefficients, it may be considered as a polynomial in [symbol] (x, y, α, β) ∈Fₚ[x, y, α, β]. Even though the evaluator may not access it because they don't know α and β, if they know [symbol] they may be able to discover out α and β using the evaluation value of r_{A} obtained using \vec{z}. For example, suppose the evaluator knows r_{A}(x)=(x+α)² without knowing α. Then, the evaluator may calculate \vec{Vz}−\vec{MH} to obtain the evaluation value of r_{A} at color digit x. Then, the evaluator may know β from (x+β)²=c. Therefore, r_{A} and r_{B} should be randomly designated while satisfying the garbling equation setting conditions. For better understanding, the following embodiments are described.

According to an embodiment, in the case of the embodiment, r_{B} needs to be garbled. As described above, if we set r_{B}(x)=x²+2αx, the evaluator may obtain the evaluation value c=x²+2αx, and thus may also obtain α=(c−x²)/2x. To randomize r_{B}, we may set rB=x²+2αx+h(x, y) for some appropriate h(x, y)∈Fₚ[x, y] that the evaluator doesn't know. r_{B} and r_{B}y−g(x+α, y+p) should still be within span(V). We may obtain h(x, y)=y that satisfies the conditions. The random oracle H′ may output 1 digit and may be represented as shown in Equation 31 below.

$${\vec{H}}^{′} = ( {H}^{′} ( {A}_{0} ) , {H}^{′} ( {A}_{1} ) , {H}^{′} ( {A}_{2} ) , {H}^{′} ( {B}_{0} ) , {H}^{′} ( {B}_{1} ) , {H}^{′} ( {B}_{2} ) ) \qquad [ Equation 31 ]$$

According to Equation 31 above, the garbling equation for garbling rB may be represented as shown in Equation 32 below.

$$V \vec{z} = M {\vec{H}}^{′} + ( {x}^{2} + 4 α x + y ) \qquad [ Equation 32 ]$$

In Equation 32 above, the garbler may calculate \vec{z} as shown in Equation 33 below.

$${z}_{1} = {H}^{′} ( {A}_{0} ) + {H}^{′} ( {B}_{0} ) \qquad [ Equation 33 ]$$

$${z}_{2} = 2 {H}^{′} ( {A}_{1} ) + {H}^{′} ( {A}_{2} ) + 2 α$$

$${z}_{3} = 2 {H}^{′} ( {A}_{0} ) + 2 {H}^{′} ( {A}_{1} ) + 2 {H}^{′} ( {A}_{2} ) + 1$$

$${z}_{4} = 2 {H}^{′} ( {B}_{1} ) + {H}^{′} ( {B}_{2} ) + 1$$

$${z}_{5} = 2 {H}^{′} ( {B}_{0} ) + 2 {H}^{′} ( {B}_{1} ) + 2 {H}^{′} ( {B}_{2} ) .$$

And the evaluator may obtain r_{B} as shown in Equation 34 below.

$${r}_{B} ( x , y ) = {z}_{1} + {z}_{2} + {z}_{3} {x}^{2} + {z}_{4} y + {z}_{5} {y}^{2} - {H}^{′} ( {A}_{x} ) - {H}^{′} ( {B}_{y} ) . \qquad [ Equation 34 ]$$

Additional garbling for each r_{A} or r_{B} may only require 2p-1 digit ciphertext. As described above, X^{m}Yⁿ garbling requires 4(p-1) ciphertexts, i.e., takes a communication complexity of 4(p-1)λ-digits. On the other hand, according to an embodiment, only two garblings of Z=X^{m} and Z=Yⁿ need to be performed. In this case, it may have a communication complexity of 3(p-1)λ+2(2p-1)-digits.

### <Arithmetic Circuit Garbling: PRIME MODULUS>

In the embodiments described below, the construction of garbled circuits for prime modulus p are described. First, a garbling equation for the target operation circuit may be set. Next, the garbler may obtain ciphertext (e.g., garbled circuit ciphertext) by comparing the coefficients of the garbling equation and provide it to the evaluator. Finally, the evaluator may evaluate the garbling equation at the color digit using the ciphertext. If necessary, additional garbling for some portions of the garbling equation may be required as described above.

In the following description, garbling equations for various types of circuits are described.

### <Establishing Garbling Equation>

Since using 2-input random oracles significantly increases the number of ciphertexts, according to an embodiment, \vec{H} may be constructed using 1-input random oracles. M and V may also be constructed using Lagrange basis and standard basis respectively as described above. For 2-variable circuit g(X, Y), it may be set as shown in Equation 35 below.

$$\vec{H} = ( H ( {A}_{0} ) , … , H ( {A}_{p - 1} ) , H ( {B}_{0} ) , … , H ( {B}_{p - 1} ) ) \qquad [ Equation 35 ]$$

$$M = [ {ℓ}_{0} ( X ) … {ℓ}_{p - 1} ( X ) {ℓ}_{0} ( Y ) … {ℓ}_{p - 1} ( Y ) ]$$

$$V = [ 1 X … {X}^{p - 1} Y … {Y}^{p - 1} ] .$$

Then, the garbling equation may be set by discovering appropriate r_{A} and r_{B} for the target circuit. For example, garbling equations for various types of circuits may be provided as follows.

### <Addition/Constant Multiplication>

For these circuits, as described above, since free addition and point-and-permute settings for modulus p are used, garbling equations may not be necessary. In this setting, we may set Aᵢ=A₀+iΔ, Bⱼ=B₀+jΔ. For addition mod, the output label is simply Aᵢ+Bⱼ=C₀+(i+j)Δ, where C₀=A₀+B₀. Similarly, for multiplication by a non-zero constant c mod p, the output label is cAi=C₀+ciΔ, where C₀=cA₀.

<Circuits with Fan-In-1>

For target circuits with Fan-in-1, the garbling equation may be set only in Fₚ[X] or Fₚ[Y]. If the target circuit is g(X), it may be set as shown in Equation 36 below.

$$\vec{H} = ( H ( {A}_{0} ) , … , H ( {A}_{p - 1} ) ) \qquad [ Equation 36 ]$$

$$M = [ {ℓ}_{0} ( X ) … {ℓ}_{p - 1} ( X ) ]$$

$$V = [ 1 X … {X}^{p - 1} ] .$$

According to an embodiment, since g(X+α) is already in span(V)=Fₚ[X], r_{A}=r_{B}=0 may be set. Then, the garbling equation may be set as shown in Equation 37 below.

$$C + {G}_{1} X + … + {G}_{p - 1} {X}^{p - 1} = M \vec{H} - g ( X + α ) Δ . \qquad [ Equation 37 ]$$

This may require p-1 ciphertexts to garble g(X).

### <Multiplication Circuit>

According to an embodiment, \vec{H}, M and V may be set as described above, and the garbling equation may be set as shown in Equation 38 below.

$$V [ \begin{matrix}C \\ \vec{G}\end{matrix} ] = M \vec{H} + {r}_{A} ( {A}_{0} + X Δ ) + {r}_{B} ( {B}_{0} + Y Δ ) - ( X + α , Y + β ) Δ \qquad [ Equation 38 ]$$

Here, \vec{G}=(G₁, . . . , G₂₍ₚ₋₁₎) may be used. In the (X+α)(Y+β)Δ term, only A does not belong to span(V). Therefore, we may set r_{A}=Y and r_{B}=0 to eliminate Δ. Then, the garbling equation may be represented as shown in Equation 39 below.

$$V [ \begin{matrix}C \\ \vec{G}\end{matrix} ] = M \vec{H} + Y ( {A}_{0} + X Δ ) - ( X + α ) ( Y + β ) Δ . \qquad [ Equation 39 ]$$

This may require 2(p-1) ciphertexts to garble the multiplication circuit.

$$〈 s ( X ) Y + Xt ( Y ) 〉$$

In the garbling equation, polynomials r_{A}, r_{B} and r_{A}X+r_{B}Y−g(X, Y) should be within span(V) since A₀, B₀ and Δ are selected independently. If \vec{H}, M and V are used as 4, r_{A} and r_{B} should be polynomials of the form r₁(X)+r₂(Y).

### <Formal Description>

The following presents a formal description of the garbling structure.

### <Circuit>

B_{y} selecting a topological order of inputs and gates, we represent circuit f=(inputs, outputs, in, eval). Inputs may be set as the number of inputs, and |f| may be allowed to be the total number of inputs and gates. In other words, there may be (|f|-inputs) gates in the circuit. Each gate may be indexed by an integer g∈[inputs+1, |f|]. Gate g has one or two inputs according to its type. The input(s) for gate g may be indexed as in₁(g) and in₂(g) if g uses two inputs, and as in₁(g) if g has only one input. We may consider 4 types of gates denoted by eval(g). Each may be set as follows (all defined on modulo p):
EVAL_{P}: X→P(X), a 1-input gate that outputs the evaluation of polynomial P(X) at the given input
ADD: (X, Y)→X+Y, a 2-input gate that adds the given inputs
MUL: (X, Y)→XY, a 2-input gate that multiplies the given inputs
EnM_{s,t}: (X, Y)→Ys(X)+Xt(Y), a 2-input gate parameterized by two polynomials s, t∈Fₚ[X]. Taking (X, Y)∈F²ₚ as input, it returns Ys(X)+Xt(Y)∈Fₚ.

### Structure According to Embodiment

The structure according to an embodiment may be implemented as illustrated in Tables 2 to 6 below.

TABLE 2

```
Gb(1*, f):
  H ← [symbol]
  Δ ← Fₚ_{^{λ−1}}||1
  for k = 1 to inputs:
    Wₖ ← Fₚ_{^{λ−1}}||0
    πₖ ← Fₚ
  for k = inputs + 1 |f|:
    A₀, B₀ := Wᵢₙ₁₍ₖ₎, Wᵢₙ_{₂}₍ₖ₎
    π_{A}, π_{B} := πᵢₙ_{₁}₍ₖ₎_{, π}_{ᵢₙ}_{₂}₍ₖ₎
    for [symbol]     = 1 to p − 1: [symbol]
      , [symbol]     := [symbol]    ₋₁ + Δ, [symbol]     + Δ
    if eval(k) = ADD;
      Wₖ := A₀ + B₀
      πₖ := π_{A} + π_{B}
    else if eval(k) = EXP_{d}: x->f(x) gate?
```

```
TABLE 3
  $[ \begin{matrix}C \\ {G}_{k , 1} \\ ⋮ \\ {G}_{k , p - 1}\end{matrix} ] := {V}_{p}^{- 1} [ \begin{matrix}H ( {A}_{0} , k ) - {π}_{A}^{d} Δ \\ ⋮ \\ H ( {A}_{p - 1} , k ) - ( {π}_{A} + p - {1}^{d} Δ\end{matrix} ]$
  \vec{G}ₖ := (G_{k,1}, ... ,G_{k,2p-1})^{T}
  \vec{z}ₖ := ⊥
  πₖ := color(C)
  Wₖ := C − πₖΔ
else if aval(k) = MUL:
  $[ \begin{matrix}C \\ {G}_{k , 1} \\ ⋮ \\ {G}_{k , p - 1} \\ {G}_{k , p} \\ ⋮ \\ {G}_{k , 2 p - 2}\end{matrix} ] := {V}_{p , biv}^{- 1} [ \begin{matrix}H ( {A}_{0} , 2 k - 2 ) + H ( {B}_{0} , 2 k - 1 ) - {π}_{A} {π}_{B} Δ \\ H ( {A}_{1} , 2 k - 2 ) + H ( {B}_{0} , 2 k - 1 ) - ( {π}_{A} + 1 ) {π}_{B} Δ \\ ⋮ \\ H ( {A}_{p - 1} , 2 k - 2 ) + H ( {B}_{0} , 2 k - 1 ) - ( {π}_{A} + p - 1 ) {π}_{B} Δ \\ H ( {A}_{0} , 2 k - 2 ) + H ( {B}_{1} , 2 k - 1 ) + {A}_{1} - {π}_{A} ( {π}_{B} + 1 ) Δ \\ ⋮ \\ H ( {A}_{0} , 2 k - 2 ) + H ( {B}_{p - 1} , 2 k - 1 ) + ( p - 1 ) {A}_{p - 1} - {π}_{A} ( {π}_{B} + p - 1 ) Δ\end{matrix} ]$
  \vec{G}ₖ := (G_{k,1}, ... ,G_{k,2p-2})^{T}
  \vec{z}ₖ := ⊥
  πₖ := color(C)
  Wₖ := C − πₖΔ
else if eval(k) = EnM_{s,t}:
  τ(X, Y) := s(X)Y + Xt(Y) // a target function
  h_{A} ←ᵤ [symbol]  [X], h_{B} ←ᵤ [symbol]  [Y]
  r_{A}(X, Y) := −t(Y + β) + h_{A}(X)
  r_{B}(X, Y) := −s(X + α) + h_{B}(Y)
```

TABLE 4
ϕ(X, Y) := r_{A}(X, Y)(A₀ + XΔ) + r_{B}(X, Y)(B₀ + YΔ) − τ(X + α, Y + β)Δ
\vec{r}_{A} := (r_{A}(0, 0), r_{A}(1, 0), ... , r_{A}(p − 1, 0), r_{A}(0,1), ... , r_{A}(0, p − 1))^{T}
\vec{r}_{B} := (r_{B}(0, 0), r_{B}(1, 0), ... , r_{B}(p − 1, 0), r_{B}(0,1), ... , r_{B}(0, p − 1))^{T}
\vec{ϕ} := (ϕ(0, 0), ϕ(1, 0), ... , ϕ(p − 1, 0), ϕ(0, 1), ... , ϕ(0, p − 1))^{T}
\vec{H}_{A} := (H(A₀, 2k − 2), H(A₁, 2k − 2), ... , H(Aₚ₋₁, 2k − 2), H(A₀, 2k − 2), ... , H(A₀, 2k − 2))^{T}
\vec{H}_{B} := (H(B₀, 2k − 1), H(B₀, 2k − 1), ... , H(B₀, 2k − 1), H(B₁, 2k − 1), ... , H(Bₚ₋₁, 2k − 1))^{T}
$[ \begin{matrix}C \\ {\vec{G}}_{k}\end{matrix} ] \vert \vert {\vec{z}}_{k , A}^{} \vert \vert {\vec{z}}_{k , B}^{} := {V}_{p , biv}^{- 1} ( {\vec{H}}_{A} + {\vec{H}}_{B} ) + {V}_{p , biv}^{- 1} ( \vec{ϕ} \vert \vert {\vec{r}}_{A} \vert \vert {\vec{r}}_{B} )$
${\vec{z}}_{k}^{} := {( {\vec{z}}_{k , A}^{T} , {\vec{z}}_{k , B}^{T} )}^{T}$
πₖ = color(C)
Wₖ := C − πₖΔ
for k ∈ outputs, μ ∈ [symbol] :
${D}_{k}^{μ} := H ( {W}_{k} + ( {π}_{k} + μ ) Δ , k )$
return F = (f, H, \vec{G}, \vec{z}), e = (Δ, W, π), d = (f, D)

```
TABLE 5
Ev(F = (f, H, \vec{G}, \vec{z}), E):
  for k = inputs + 1 to |f|:
    A, B = Eᵢₙ_{₁}₍ₖ₎, Eᵢₙ_{₂₍}ₖ₎
    i, j = color(A), color(B)
    if eval(k) = ADD:
      Eₖ := A + B
    else if eval(k) = EXP_{d}: x ->f(x) gate?
      Eₖ := H(A, 2k − 2) + (i, i², ... , i^{p-1}) · \vec{G}ₖ
    else if eval(k) = MUL:
      Eₖ := H(A, 2k − 2) + H(B, 2k − 1) + (i, i², ... , i^{p-1}, j, j², ... , j^{p-1}) · \vec{G}ₖ
    else if eval(k) = EnM_{s,t}:
      $parse {\vec{z}}_{k} into {( {\vec{z}}_{k , A}^{T} , {\vec{z}}_{k , B}^{T} )}^{T}$
      ${X}_{ij} \vert \vert {r}_{A , ij} \vert \vert {r}_{B , ij} := H ( A , 2 k - 2 ) + H ( B , 2 k - 1 ) + ( 1 , i , {i}^{2} , … , {i}^{p - 1} , j , {j}^{2} , … , {j}^{p - 1} ) \cdot ( [ \begin{matrix}0 \\ {\vec{G}}_{k}\end{matrix} ] \vert \vert {\vec{z}}_{k , A} \vert \vert {\vec{z}}_{k , B} )$
      Eₖ := Xᵢⱼ + r_{A,ij}A + r_{B,ij}B
return E
```

TABLE 6

| En(e = (Δ, W, π), x): | De(d = (f. D), E): |
|---|---|
| for k = 1 to inputs: | y ={} // empty set |
| Eₖ := Wₖ + (xₖ + πₖ)Δ | for k ∈ outputs, [symbol] ∈ [symbol] : |
| return E | $if {D}_{k}^{ℓ} = H ( {E}_{k} , k ) :$ |
| | append [symbol] to y |
| | else: return ⊥ |
| | return y |

Referring to Tables 2 to 6 above, according to an embodiment, the garbler may select a random λ-dimensional vector Wₖ with least significant digit 0. Further, point-and-permute digit πk may be obtained. The kth wire label encoding μ∈Fₚ may be designated as Wₖ+(μ+πₖ)Δ. In other words, Wₖ is the wire label corresponding to operation value −πₖ.

According to an embodiment, span(V) may be F_{p*}[x] or F_{p*}[x]+F_{p*}[y] according to the number of inputs for gate g. In the former case where eval(g)=EVALₚ, we may set M and \vec{H} such that \vec{MH}=H(Aₓ) and r_{A}=r_{B}=0. Therefore, evaluating Equation 19 at κ=i yields the result shown in Equation 40 below.

$$C + {G}_{1} i + … + {G}_{p - 1} {i}^{p - 1} = H ( {A}_{i} ) + P ( i ) Δ . \qquad [ Equation 40 ]$$

Similarly, running for i from 0 to p-1, it may be represented as shown in Equation 41 below.

$${{V}_{p} ( C , {G}_{1} , … , {G}_{p - 1} )}^{⊤} = {( ⋯ , H ( {A}_{i} ) + P ( i ) Δ , ⋯ )}^{⊤} , \qquad [ Equation 41 ]$$

In Equation 41 above, Vₚ is the Vandermonde matrix of degree p as shown in Equation 42 below.

$${V}_{p} := [ \begin{matrix}1 & 0 & ⋯ & 0 \\ 1 & 1 & ⋯ & {1}^{p - 1} \\ ⋮ & ⋮ & ⋱ & ⋮ \\ 1 & p - 1 & ⋯ & {( p - 1 )}^{p - 1}\end{matrix} ] . \qquad [ Equation 42 ]$$

From the equation of Equation 42, the garbler may derive C and Gᵢ by multiplying Vₚ⁻¹ to the vector ( . . . , H(Aᵢ)+P(i)Δ, . . . )^{T}.

According to an embodiment, in the latter case where eval(g)≠EVAL_{P}, the garbling equation may be represented as a bivariate polynomial. The bivariate polynomial appearing on the right side of Equation 19 above may be denoted as F(x, y)∈F_{p*}[x,y]. For each i, j∈Fₚ, evaluation at (x, y)=(i, 0) or (0, j) may be considered. This may lead to considering univariate equations of the form of either Equation 43 or 44 below.

$$C + {C}_{1} i + ⋯ + {G}_{p - 1} {i}^{p - 1} = ( i , 0 ) , \qquad [ Equation 43 ]$$

$$C + {C}_{p} j + ⋯ + {G}_{2 p - 2} {j}^{p - 1} = ( 0 , j ) , \qquad [ Equation 44 ]$$

Similar to before, this may be rewritten as shown in Equation 45 below.

$${{V}_{p , biv} ( C , {G}_{1} , … , {G}_{p - 1} , {G}_{p} , … , {G}_{2 p - 1} )}^{⊤} = {( ℱ ( 0 , 0 ) , ℱ ( 1 , 0 ) , … , ℱ ( p - 1 , 0 ) , \\ ℱ ( 0 , 1 ) , … , ℱ ( 0 , p - 1 ) )}^{⊤} . \qquad [ Equation 45 ]$$

Here, the bivariate version of the Vandermonde matrix V_{p,biv} may be represented as shown in Equation 46 below.

$${V}_{p , biv} := [ \begin{matrix}1 & 0 … 0 & 0 \\ 1 & & \\ ⋮ & {\hat{V}}_{p} & {0}_{p - 1} \\ 1 & & \\ 1 & & \\ ⋮ & {0}_{p - 1} & {\hat{V}}_{p} \\ 1 & & \end{matrix} ] , \qquad [ Equation 46 ]$$

Here, 0ₚ₋₁ is a square zero matrix of dimension p-1, and \hat{V}ₚ is a submatrix obtained by removing the first row and first column from Vp. We may identify that V_{p,biv} is an invertible matrix of dimension 2p-1. As before, the garbler may calculate C and Gᵢ by applying

$${V}_{p , biv}^{- 1}$$

to the vector ( . . . , F(i, 0), . . . , F(0, j), . . . )^{T}.

As described above, in some cases, several elements of the garbling equation should also be garbled. Specifically, when eval(g)=EnM_{s,t}, the garbler should add constant-size ciphertext encoding information about r_{A} and r_{B}. For this, additional queries to the random oracle need to be performed. However, to avoid unnecessary additional calls to H, we assume that the range of H is extended by the amount necessary to garble r_{A} and r_{B}. Since we need one Fₚ-element for each garbling of r_{A} and r_{B}, we may set H to have a range of F_{p*}×Fₚ_{²}. According to an embodiment, since we write Fₚ-vectors in big endian order, H tm msd_{λ}(H)∥lsd₂(H) may be used. Here, msd_{λ} and lsd₂ represent the λ most significant digits and two least significant digits respectively. Then, using concatenation, the garbling equations for the main ciphertext and additional constant-size ciphertext \vec{z}=(\vec{z}_{A}, \vec{z}_{B}) may be set as shown in Equation 47 below.

$${V}_{p , biv} ( [ \begin{matrix}C \\ \vec{G}\end{matrix} ] ‖ {\vec{z}}_{A} ‖ {\vec{z}}_{B} ) = \vec{h} + ( \vec{ϕ} ‖ {\vec{r}}_{A} ‖ {\vec{r}}_{B} ) . \qquad [ Equation 47 ]$$

Here, \vec{h}=( . . . , H(Aᵢ)+H(B₀), . . . , H(A₀)+H(Bⱼ), . . . )^{T}, where i (j respectively) may range from 0 (1 respectively) to 1. And φ may be defined as a polynomial such that F(x, y)=H(Ax)+H(By)+φ(x, y). Therefore, \vec{ϕ}, \vec{r}_{A} and \vec{r}_{B} are vectors obtained by evaluating each polynomial in the operation for (i, 0) and (0, j).

Although we omitted tweaks in H for simplification in the description, the formal description may include tweaks based on gate indices for domain separation such as H(A, 2g-2) and H(B, 2g-1).

According to an embodiment, in the Ev algorithm, the evaluator may start with input wire labels. For each gate k, the evaluator may perform appropriate operations to calculate Eₖ. Eventually, they will hold the active wire label Eₖ corresponding to xₖ. Here, xₖ may be the basic arithmetic value of the corresponding wire.

### <Security Proofs>

Hereinafter, the security of the structure according to the embodiments may be proven. The construction according to an embodiment may require a hash function with a property called circular correlation robustness (CCR). For example, most free-XOR based constructions may rely on the CCR property (or its variants) for security. One relevant definition in this context is tweakable CCR (TCCR), which is briefly recalled here.

### <Circular Correlation Robustness (CCR)>

Let H be a hash function and define oracle O^{H}_{Δ}(X, g, b):=H(X+Δ, g)+bΔ. Here, X, Δ∈F₂_{^{k}}, b∈F₂, and g may be any string. If O^{H}_{Δ} is indistinguishable from a random oracle under the condition that the attacker does not repeat one pair (X, g) for oracle queries, H may be referred to as TCCR. For example, the security of the half-gate technique may be proven under the assumption that H is TCCR.

Since the structure according to an embodiment aims at garbling arithmetic circuits, the following modified definition of TCCR may be used. For example, the embodiments consider the domain/range of H for ring modulo p.

According to an embodiment, H may be set as a hash function mapping {0, 1}ⁿ×T→{0, 1}ⁿ for some set of tweaks T. It may be assumed that n-bit strings may be represented as elements of F_{p*} for appropriate choices of prime p and integer λ. Oracle O^{H}_{Δ} may be represented as shown in Equation 48 below.

$${O}_{Δ}^{H} ( X , g , a , b ) := H ( X + a Δ , g ) + b Δ , \qquad [ Equation 48 ]$$

Here, X, Δ∈F_{p*}, a, b ∈ Fₚ, and g∈T may be used. Addition operations may be performed on F_{p*}.

According to an embodiment, if oracle O^{H}_{Δ} may be distinguished from a random oracle for all polynomial-time adversaries querying for a≠0 and unique g, hash function H may be said to be Modulus-adjustable Circular Correlation Robustness (Mod-TCCR). According to an embodiment, the following assumptions may be used.

(Basic) Modulus-TCCR definition: (X+aΔ, τ)+bΔ is random for a, b∈Z.

(RR variant) Modulus-RTCCR definition: H is taken from a family, and the description of H may be revealed to the adversary after performing all oracle queries.

(GKWY variant) Define Modulus-TCCR for naturally derived keys: extending the definition and “natural sequence” from the GKWY paper.

For simplification, only the “basic” definition may be considered, and according to embodiments, the definition may be relaxed as RR or GKWY.

According to an embodiment, if each row of the inverse of the Vandermonde matrix has at least 2 non-zero elements, the Mod-TCCR assumption may be applied.

The embodiments may be utilized for operations known as secure multiparty computation (SMC) or secure function evaluation (SFE) as a problem of computing functions with private key inputs. Further, garbled circuits may be used to provide solutions for important problems in various areas including IP protection (function evaluation without knowing what the function is), healthcare (analysis without revealing medical records), biometrics (comparison without revealing biometric information), private database-as-a-service (hosting and processing queries on customer data hidden from the processor), cloud-based machine learning (protecting proprietary models from customers, protecting sensitive customer data from processors), and more.

An electronic device according to an embodiment may include memory, a communication circuit, and a processor electrically connected to the memory and the communication circuit, wherein the processor may be configured to identify at least one garbled circuit ciphertext generated based on a garbling equation set corresponding to a target operation from the memory, transmit (e.g., provide) the identified at least one garbled circuit ciphertext to an evaluator device through the communication circuit, receive (e.g., obtain) a first result value of the garbling equation corresponding to at least one input value from the evaluator device through the communication circuit, and identify a second result value of the target operation corresponding to the at least one input value based on the first result value.

According to an embodiment, an electronic device includes: memory storing instructions; a communication circuit; and at least one processor, wherein the instructions, when executed by the at least one processor individually or collectively, cause the electronic device to: identify at least one garbled circuit ciphertext generated based on a garbling equation set corresponding to a target operation from the memory; provide the identified at least one garbled circuit ciphertext to an evaluator device through the communication circuit; obtain a first result value of the garbling equation corresponding to at least one input value from the evaluator device through the communication circuit; and identify a second result value of the target operation corresponding to the at least one input value based on the first result value.

According to an embodiment, the garbling equation may be set based on a number of at least one variable included in the target operation and a domain for the at least one variable.

According to an embodiment, the garbling equation may be set based on a degree of at least one variable included in the target operation.

According to an embodiment, the first result value may be generated by the evaluator device based on the at least one garbled circuit ciphertext.

According to an embodiment, the instructions may cause the electronic device receive the at least one input value from the evaluator device, generate a random bit string of a set number of bits based on the received at least one input value, and transmit the generated random bit string to the evaluator device.

According to an embodiment, the at least one garbled circuit ciphertext may be generated based on coefficients included in the garbling equation.

According to an embodiment, when the target operation is a multiplication operation of x and y, the garbling equation may correspond to Equation 49 below.

$$C + {xG}_{1} + {yG}_{2} = M \vec{H} + {yA}_{x} + ( x + α ) ( y + β ) Δ \qquad [ Equation 49 ]$$

Here, x and y are input values, C, G₁, and G₂ are coefficients of the garbling equation, M is a matrix set to output 1 when each input value is 0, \vec{H} is a hash vector corresponding to each input value, α and β are permutation bits of the garbler, and Δ is a variable for offset.

According to an embodiment, the at least one garbled circuit ciphertext may include the G₁ and the G₂.

According to an embodiment, when the target operation is a square operation of x, the garbling equation may correspond to Equation 50 below.

$$C + {xG}_{1} + {x}^{2} {G}_{2} = M \vec{H} - {( x + α )}^{2} Δ \qquad [ Equation 50 ]$$

Here, x is an input value, C, G₁, and G₂ are coefficients of the garbling equation, M is a matrix set to output 1 when each input value is 0, \vec{H} is a hash vector corresponding to the input value, α is a permutation bit of the garbler, and Δ is a variable for offset.

According to an embodiment, the at least one garbled circuit ciphertext may include the G₁ and the G₂.

A method of operating an electronic device according to an embodiment, in a method for performing an encrypted operation in an electronic device, may include an operation of identifying at least one garbled circuit ciphertext generated based on a garbling equation set corresponding to a target operation, an operation of transmitting the identified at least one garbled circuit ciphertext to an evaluator device, an operation of receiving a first result value of the garbling equation corresponding to at least one input value from the evaluator device, and an operation of identifying a second result value of the target operation corresponding to the at least one input value based on the first result value.

According to an embodiment, the garbling equation may be set based on a number of at least one variable included in the target operation and a domain for the at least one variable.

According to an embodiment, the garbling equation may be set based on a degree of at least one variable included in the target operation.

According to an embodiment, the first result value may be generated by the evaluator device based on the at least one garbled circuit ciphertext.

According to an embodiment, the method may further include an operation of receiving the at least one input value from the evaluator device, an operation of generating a random bit string of a set number of bits based on the received at least one input value, and an operation of transmitting the generated random bit string to the evaluator device.

According to an embodiment, the at least one garbled circuit ciphertext may be generated based on coefficients included in the garbling equation.

According to an embodiment, when the target operation is a multiplication operation of x and y, the garbling equation may correspond to Equation 51 below.

$$C + {xG}_{1} + {yG}_{2} = M \vec{H} + {yA}_{x} + ( x + α ) ( y + β ) Δ \qquad [ Equation 51 ]$$

Here, x and y are input values, C, G₁, and G₂ are coefficients of the garbling equation, M is a matrix set to output 1 when each input value is 0, \vec{H} is a hash vector corresponding to each input value, α and β are permutation bits of the garbler, and Δ is a variable for offset.

According to an embodiment, the at least one garbled circuit ciphertext may include the G₁ and the G₂.

According to an embodiment, when the target operation is a square operation of x, the garbling equation may correspond to Equation 52 below.

$$C + {xG}_{1} + {x}^{2} {G}_{2} = M \vec{H} - {( x + α )}^{2} Δ \qquad [ Equation 52 ]$$

Here, x is an input value, C, G₁, and G₂ are coefficients of the garbling equation, M is a matrix set to output 1 when each input value is 0, \vec{H} is a hash vector corresponding to the input value, α is a permutation bit of the garbler, and Δ is a variable for offset.

According to an embodiment, the at least one garbled circuit ciphertext may include the G₁ and the G₂.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions;
a communication circuit; and
at least one processor,
wherein the instructions, when executed by the at least one processor individually or collectively, cause the electronic device to:
identify, from the memory, at least one garbled circuit ciphertext generated based on a garbling equation set corresponding to a target operation;
provide, through the communication circuit, the identified at least one garbled circuit ciphertext to an evaluator device;
obtain, through the communication circuit, a first result value of the garbling equation corresponding to at least one input value from the evaluator device; and
based on the first result value, identify a second result value of the target operation corresponding to the at least one input value.

2. The electronic device of claim 1, wherein the garbling equation is set based on a number of at least one variable included in the target operation and a domain for the at least one variable.

3. The electronic device of claim 1, wherein the garbling equation is set based on a degree of at least one variable included in the target operation.

4. The electronic device of claim 1, wherein the first result value is generated by the evaluator device based on the at least one garbled circuit ciphertext.

5. The electronic device of claim 1, wherein the instructions cause the electronic device to:
obtain the at least one input value from the evaluator device;
based on the obtained at least one input value, generate a random bit string of a set number of bits; and
provide the generated random bit string to the evaluator device.

6. The electronic device of claim 1, wherein the at least one garbled circuit ciphertext is generated based on coefficients included in the garbling equation.

7. The electronic device of claim 1, wherein based on the target operation being a multiplication operation of x and y, the garbling equation corresponds to:
$$C + {xG}_{1} + {yG}_{2} = M \vec{H} + {yA}_{x} + ( x + α ) ( y + β ) Δ$$
where x and y are input values, C, G₁, and G₂ are coefficients of the garbling equation, M is a matrix set to output 1 when each input value is 0, \vec{H} is a hash vector corresponding to each input value, α and β are permutation bits of a garbler, and Δ is a variable for offset.

8. The electronic device of claim 7, wherein the at least one garbled circuit ciphertext includes the G₁ and the G₂.

9. The electronic device of claim 1, wherein based on the target operation being a square operation of x, the garbling equation corresponds to:
$$C + {xG}_{1} + {x}^{2} {G}_{2} = M \vec{H} - {( x + α )}^{2} Δ$$
where x is an input value, C, G₁, and G₂ are coefficients of the garbling equation, M is a matrix set to output 1 when each input value is 0, \vec{H} is a hash vector corresponding to the input value, α is a permutation bit of a garbler, and Δ is a variable for offset.

10. The electronic device of claim 9, wherein the at least one garbled circuit ciphertext includes the G₁ and the G₂.

11. A method for performing an encrypted operation in an electronic device, the method comprising:
identifying at least one garbled circuit ciphertext generated based on a garbling equation set corresponding to a target operation;
providing the identified at least one garbled circuit ciphertext to an evaluator device;
obtaining a first result value of the garbling equation corresponding to at least one input value from the evaluator device; and
based on the first result value, identifying a second result value of the target operation corresponding to the at least one input value.

12. The method of claim 11, wherein the garbling equation is set based on a number of at least one variable included in the target operation and a domain for the at least one variable.

13. The method of claim 11, wherein the garbling equation is set based on a degree of at least one variable included in the target operation.

14. The method of claim 11, wherein the first result value is generated by the evaluator device based on the at least one garbled circuit ciphertext.

15. The method of claim 11, further comprising:
obtaining the at least one input value from the evaluator device;
based on the obtained at least one input value, generating a random bit string of a set number of bits; and
transmitting the generated random bit string to the evaluator device.

16. The method of claim 11, wherein the at least one garbled circuit ciphertext is generated based on coefficients included in the garbling equation.

17. The method of claim 11, wherein based on the target operation being a multiplication operation of x and y, the garbling equation corresponds to:
$$C + {xG}_{1} + {yG}_{2} = M \vec{H} + {yA}_{x} + ( x + α ) ( y + β ) Δ$$
where x and y are input values, C, G₁, and G₂ are coefficients of the garbling equation, M is a matrix set to output 1 when each input value is 0, \vec{H} is a hash vector corresponding to each input value, α and β are permutation bits of a garbler, and Δ is a variable for offset.

18. The method of claim 17, wherein the at least one garbled circuit ciphertext includes the G₁ and the G₂.

19. The method of claim 11, wherein based on the target operation being a square operation of x, the garbling equation corresponds to:
$$C + {xG}_{1} + {x}^{2} {G}_{2} = M \vec{H} - {( x + α )}^{2} Δ$$
where x is an input value, C, G₁, and G₂ are coefficients of the garbling equation, M is a matrix set to output 1 when each input value is 0, \vec{H} is a hash vector corresponding to the input value, α is a permutation bit of a garbler, and Δ is a variable for offset.

20. The method of claim 19, wherein the at least one garbled circuit ciphertext includes the G₁ and the G₂.
